(19) United States
(12) Patent Application Publication
(10) Pub. No.: US 2015/0230135 A1
(43) Pub. Date: Aug. 13, 2015

(54) INTER RADIO ACCESS TECHNOLOGY CELLULAR HANDOVER

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/176,588

(22) Filed: Feb. 10, 2014

(51) Int. Cl. H04W 36/00; H04W 72/12; H04L 5/00; H04W 74/08

(52) U.S. Cl. CPC H04W 36/0022; H04W 74/0833; H04W 72/1215; H04L 5/0055

(57) ABSTRACT

A user equipment (UE) sends random access request and scheduling requests for channels, such as a physical random access channel (PRACH) and a random access uplink control channel (E-RUCCH), in parallel rather than serially to improve data transmission latency. In one instance, the UE transmits a first preamble for a random access procedure and a second preamble for a scheduling request in response to receiving a hard-handover command. The UE receives a first acknowledgment response to one of the preambles. The UE determines when to transmit the scheduling request based at least in part on which preamble is acknowledged.

### BACKGROUND

1. Field

Aspects of the present disclosure relate generally to wireless communication systems, and more particularly, to an inter radio access technology hard handover method for reducing data transmission interruptions in a cellular network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes transmitting a first preamble for a random access procedure and a second preamble for a scheduling request in response to receiving a hard-handover command. The method also includes receiving a first acknowledgment response to one of the preambles. The method further includes determining when to transmit the scheduling request based at least in part on which preamble is acknowledged.

According to another aspect of the present disclosure, an apparatus for wireless communication includes means for transmitting a first preamble for a random access procedure and a second preamble for a scheduling request in response to receiving a hard-handover command. The apparatus also includes means for receiving a first acknowledgment response to one of the preambles. The apparatus further includes means for determining when to transmit the scheduling request based at least in part on which preamble is acknowledged.

According to one aspect of the present disclosure, an apparatus for wireless communication includes a memory and a processor(s) coupled to the memory. The processor(s) is configured to transmit a first preamble for a random access procedure and a second preamble for a scheduling request in response to receiving a hard-handover command. The processor(s) is also configured to receive a first acknowledgment response to one of the preambles. The processor(s) is further configured to determine when to transmit the scheduling request based at least in part on which preamble is acknowledged.

According to one aspect of the present disclosure, a computer program product for wireless communication in a wireless network includes a computer readable medium having non-transitory program code recorded thereon. The program code includes program code to transmit a first preamble for a random access procedure and a second preamble for a scheduling request in response to receiving a hard-handover command. The program code also includes program code to receive a first acknowledgment response to one of the preambles. The program code further includes program code to determine when to transmit the scheduling request based at least in part on which preamble is acknowledged.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a call flow diagram illustrating an aspect of the present disclosure.

FIG. 6 is a block diagram illustrating a LTE to TD-HSUPA handover method according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

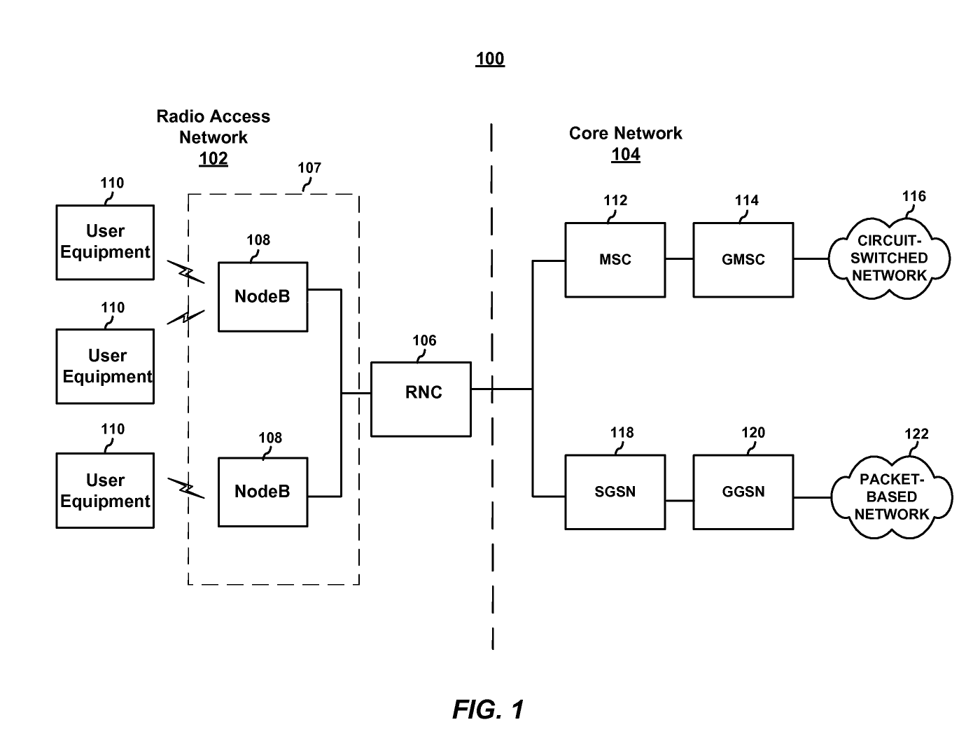

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

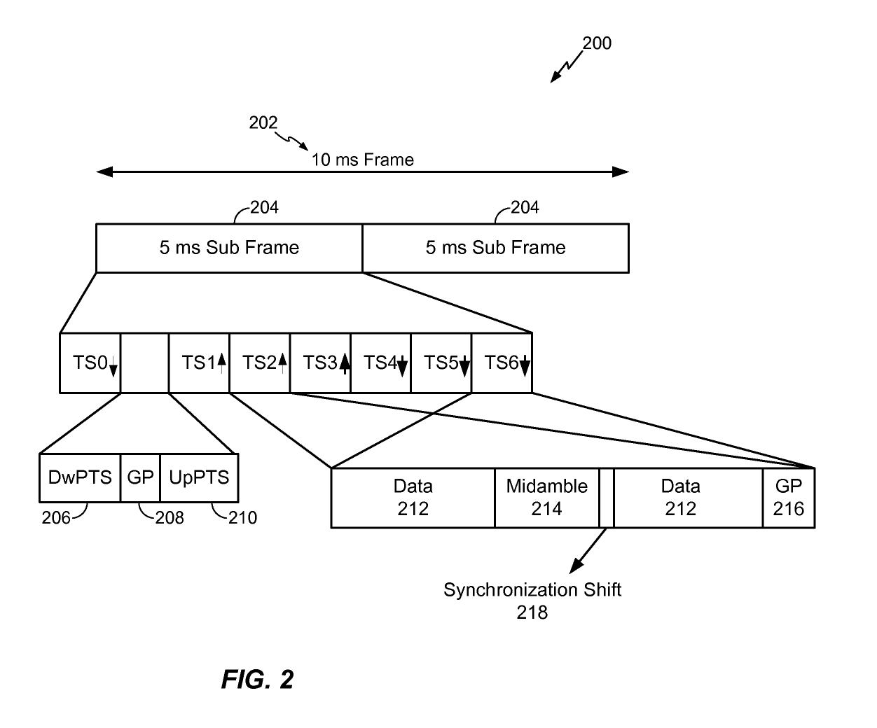

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

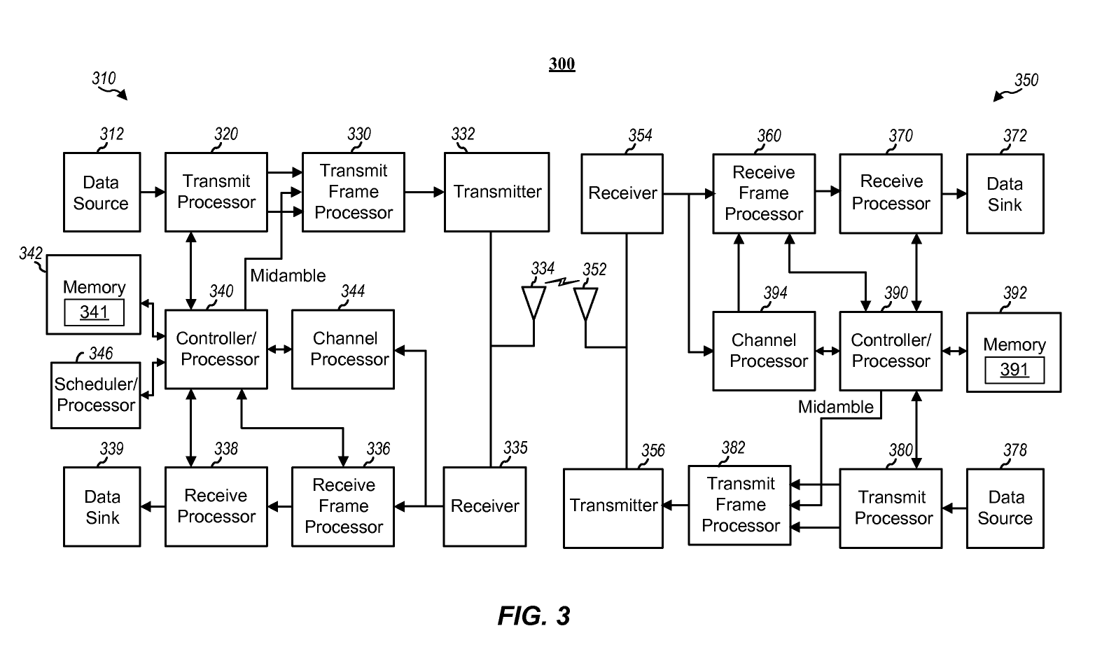

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memory 392 may store data and software for the UE 350. For example, the memory 392 of the UE 350 may store a preamble transmitting module 391 which, when executed by the controller/processor 390, configures the UE 350 to transmit a preamble for a random access procedure and also transmit a preamble in response to a scheduling request.

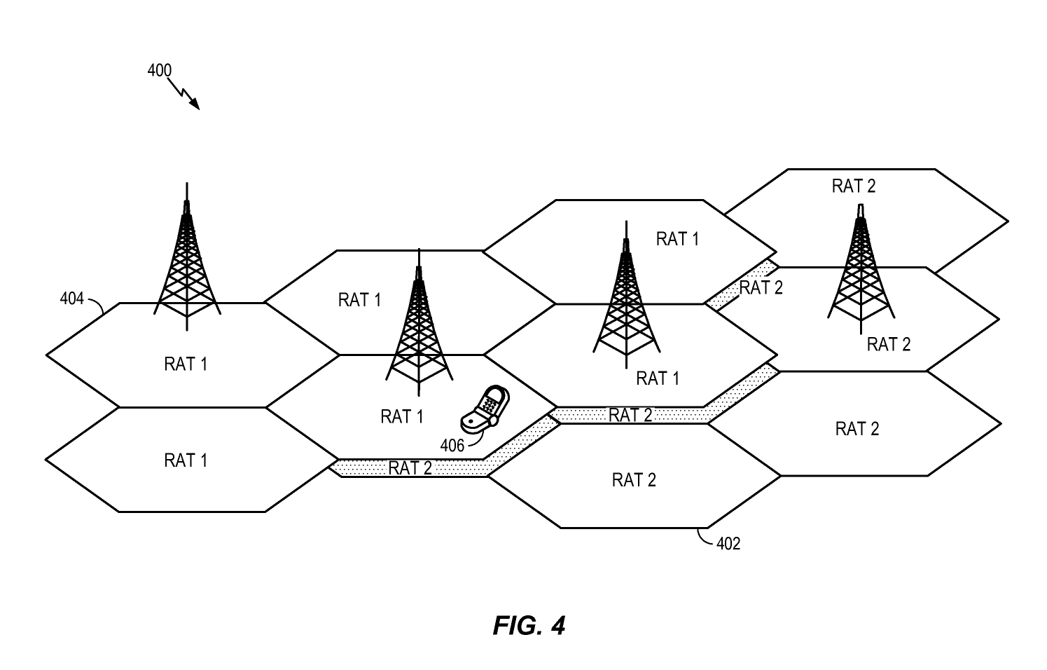

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (i.e., RAT-1), such as a TD-HSUPA network, and also illustrates a newly deployed network utilizing a second type of radio access technology (i.e., RAT-2), such as an LTE network. The geographical area 400 includes RAT-1 cells 402 and RAT-2 cells 404. In one example, the RAT-1 cells are TD-HSUPA cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

Handover from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

High speed uplink packet access (HSUPA) or time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NAK signals.

The operation of TD-HSUPA may also have the following steps. First, in the resource request step, the UE sends requests (e.g., via scheduling information (SI)) via the E-PUCH or the E-RUCCH to a base station (e.g., NodeB). The requests are for permission to transmit on the uplink channels. Next, in a resource allocation step, the base station, which controls the uplink radio resources, allocates resources. Resources are allocated in terms of scheduling grants (SGs) to individual UEs based on their requests. In the third step (i.e., the UE Transmission step), the UE transmits on the uplink channels after receiving grants from the base station. The UE determines the transmission rate and the corresponding transport format combination (TFC) based on the received grants. The UE may also request additional grants if it has more data to transmit. Finally, in the fourth step (i.e., the base station reception step), a hybrid automatic repeat request (hybrid ARQ or HARQ) process is employed for the rapid retransmission of erroneously received data packets between the UE and the base station.

The transmission of SI (scheduling information) may consist of two types in TD-HSUPA: (1) In-band and (2) Out-band. For in-band, which may be included in MAC-e PDU (medium access control e-type protocol data unit) on the E-PUCH, data can be sent standalone or may piggyback on a data packet. For Out-band, data may be sent on the E-RUCCH in case that the UE does not have a grant. Otherwise, the grant expires.

The scheduling information (SI) may include the following information or fields: the highest priority logical channel ID (HLID) field, the total E-DCH buffer status (TEBS) field, the highest priority logical channel buffer status (HLBS) field and the UE power headroom (UPH) field.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window are also be included in the TEBS. RLC PDUs that have been transmitted but not negatively acknowledged by the peer entity shall not be included in the TEBS.

LTE to TD-HSUPA Hard-Handover

Aspects of the present disclosure are directed to inter-system radio access technology (IRAT) handovers, for example from LTE to TD-HSUPA. The IRAT handover may be utilized when a UE is in a connected mode to enable a packet switched (PS) data connection transition from a source RAT to a target RAT. In particular, aspects of the present disclosure are directed to a UE sending a random access request and scheduling requests for channels, such as PRACH and E-RUCCH, in parallel rather than sending the requests serially.

LTE to TD-SCDMA handover may occur when the UE leaves LTE coverage during a packet switched call. During the initial LTE deployment, the LTE coverage is limited. LTE to TD-SCDMA handover also occurs when the UE makes a circuit switched (CS) voice call or when the UE receives pages for a circuit switched voice call while in LTE idle or connected mode. The UE is moved to TD-SCDMA via circuit switched fallback (CSFB) for simultaneous packet switched and circuit switched calls when the LTE network does not support voice over LTE.

For LTE to TD-HSUPA handover, after the UE receives a handover command, the UE sends an uplink (UL) sync sequence for the physical random access channel (PRACH). The UE then monitors the fast physical access channel (FPACH) for an acknowledgement (ACK) and a uplink timing advance (TA). The UE sends the uplink (UL) dedicated physical channel (DPCH)/special burst based on timing and/or power information carried on the FPACH. After the network detects the uplink DPCH/special burst, the network configures downlink beam forming based on the received uplink transmission. The network then begins downlink (DL) transmission. After the UE detects a downlink in-sync condition, the UE sends an UL SYNC sequence for E-RUCCH for a scheduling request. E-RUCCH is the E-DCH (enhanced dedicated channel) random access uplink control channel. This process increases data transmission latency, which negatively impacts data user perception.

In one aspect of the present disclosure, for LTE to TD-HSUPA hard handover, the UE sends preambles, (e.g., UL SYNC (uplink synchronization) sequences) for both the random access (e.g., PRACH) and scheduling request (e.g., E-RUCCH) procedures in parallel. The UE transmits the uplink DPCH or special burst based on the timing advance and/or power information carried on the acknowledgement response (e.g., FPACH) from any of the two procedures. If the preamble indicated in the acknowledgement response corresponds to the scheduling request procedure, then the UE sends a scheduling request via the E-RUCCH. If the UL SYNC sequence carried in the acknowledgement response is for the random access procedure, the UE waits until it receives the acknowledgement response corresponding to the scheduling request procedure, and then the UE sends a scheduling request.

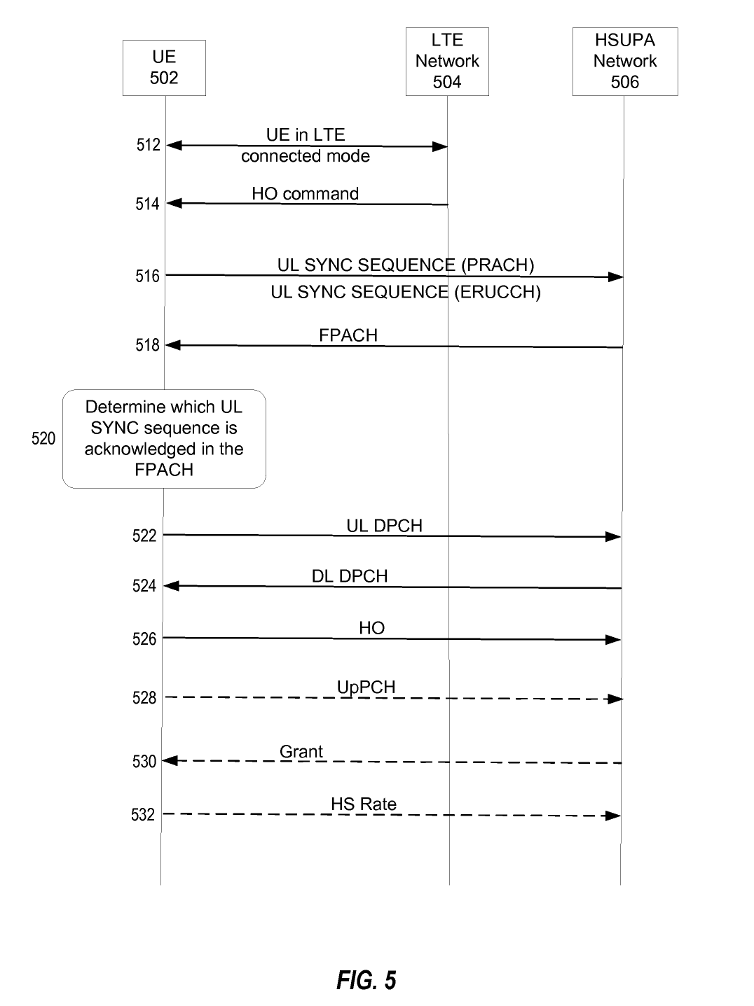

FIG. 5 illustrates an example call flow diagram for LTE to TD-HSUPA hard-handover according to an aspect of the present disclosure. At time 512, the UE 502 is in a connected mode with the LTE network 504. At time 514, the UE 502 receives a handover (HO) command from the LTE network 504. At time 516, the UE 502 transmits preambles (e.g., UL SYNC sequences) for random access (e.g., PRACH) and for a scheduling request (e.g., E-RUCCH) procedures at substantially the same time, in parallel, to the TD-HSUPA network 506.

At time 518, the UE receives an acknowledgement response (e.g., FPACH) from the TD-HSUPA network 506 in response to the UE transmissions sent at time 516. The acknowledgement response informs the UE 502 which preamble was received (e.g., either the sequence for random access or the sequence for a scheduling request). At time 520, the UE determines which preamble was acknowledged. At time 522, regardless of which preamble was received and acknowledged by the TD-HSUPA network 506, the UE transmits the uplink DPCH with the timing and/or power received in the acknowledgment response. At time 524, the TD-HSUPA network 506 begins the downlink transmission to the UE 502. The handover is completed at time 526.

Referring back to time 520, if the UE 502 determined the scheduling request preamble was indicated in the received acknowledgment response (e.g., FPACH), then at time 528, the UE 502 transmits a scheduling request (e.g., on the E-RUCCH) to the TD-HSUPA network 506. At time 530, the UE 502 receives a grant from the TD-HSUPA network 506 and then begins transmitting data at a high speed rate at time 532.

On the other hand, if the UE 502 determined the random access preamble was indicated in the received acknowledgment response (e.g., FPACH), then the UE waits for the acknowledgment response for the scheduling request procedure. Once received, at time 528 the UE 502 transmits a schedule request (e.g., on the E-RUCCH) to the TD-HSUPA network 506. At time 530, the UE 502 receives a grant from the TD-HSUPA network 506 and then begins transmitting HSUPA data at a high speed rate at time 532.

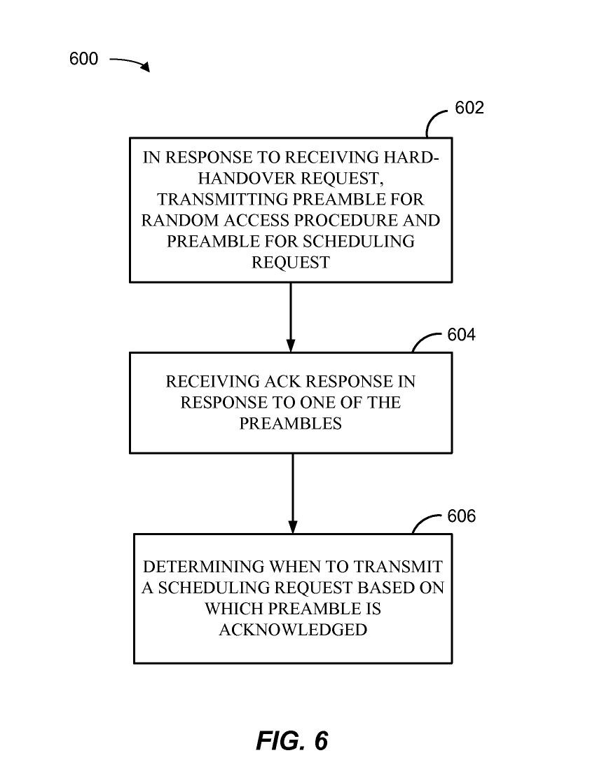

FIG. 6 shows a wireless communication method 600 according to one aspect of the disclosure. In block 602, the UE transmits a preamble for a random access procedure and a preamble for a scheduling request. The preambles are transmitted in response to the UE receiving a hard-handover command. Next, in block 604, the UE receives an acknowledgment response to one of the preambles. In block 606, the UE determines when to transmit a scheduling request based on which preamble is acknowledged.

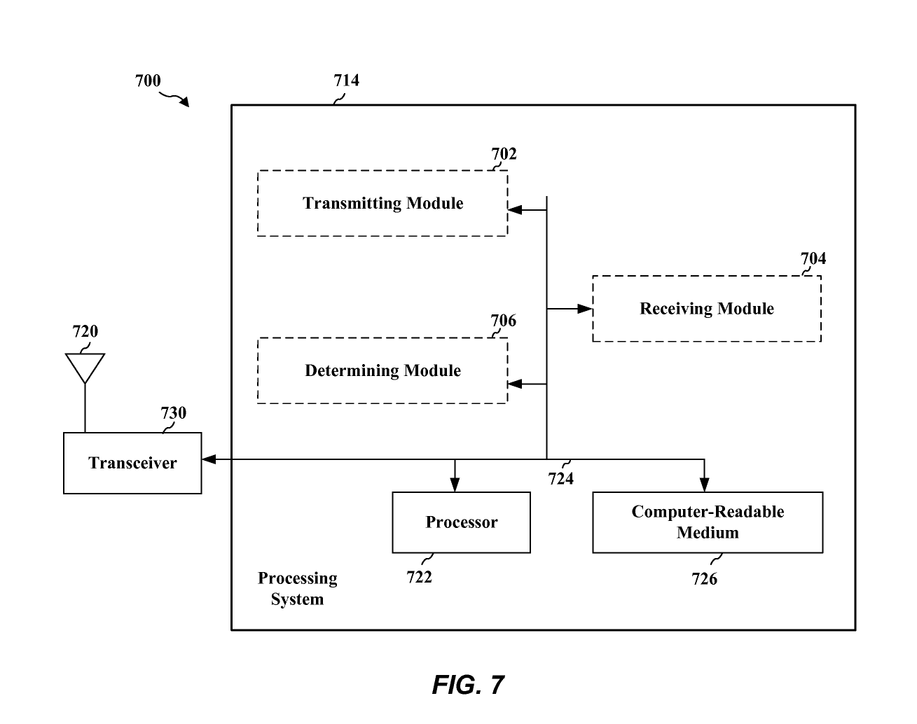

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a transmitting module 702 for transmitting a preamble for a random access procedure and a preamble for a scheduling request in response to receiving a hard-handover command. The processing system 714 includes a receiving module 704 for receiving an acknowledgment response to one of the preambles. The processing system 714 also includes a determining module 706 for determining when to transmit a scheduling request based on which preamble is acknowledged. The modules may be software modules running in the processor 722, resident/stored in the computer readable medium 726, one or more hardware modules coupled to the processor 722, or some combination thereof. The processing system 714 may be a component of the UE 350 and may include the memory 392, and/or the controller/processor 390.

In one configuration, an apparatus such as a UE 350 is configured for wireless communication including means for transmitting. In one aspect, the transmitting means may be the antennas 352, the transmitter 356, the transmit frame processor 382, the transmit processor 380, the controller/processor 390, the memory 392, parallel preamble transmitting module 391, the transmitting module 702, and/or the processing system 714 configured to perform the transmitting means. In another aspect, the aforementioned means may be any module or any apparatus configured to perform the functions recited by the aforementioned means.

The UE 350 is also configured to include means for receiving. In one aspect, the receiving means may be the antennas 352, the receiver 354, the channel processor 394, the receive frame processor 360, the receive processor 370, the controller/processor 390, the memory 392, parallel preamble transmitting module 391, receiving module 704 and/or the processing system 714 configured to perform the receiving means. In another aspect, the aforementioned means may be any module or any apparatus configured to perform the functions recited by the aforementioned means.

The UE 350 is also configured to include means for determining. In one aspect, the determining means may be the controller/processor 390, the memory 392, parallel preamble transmitting module 391, determining module 706 and/or the processing system 714 configured to perform the determining means. In another aspect, the aforementioned means may be any module or any apparatus configured to perform the functions recited by the aforementioned means.

Several aspects of a telecommunications system has been presented with reference to LTE and TD-HSUPA. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
transmitting a first preamble for a random access procedure and a second preamble for a scheduling request in response to receiving a hard-handover command;
receiving a first acknowledgment response to one of the preambles; and
determining when to transmit the scheduling request based at least in part on which preamble is acknowledged.

2. The method of claim 1, in which the first and second preambles for the random access procedure and the scheduling request are substantially simultaneously transmitted in parallel.

3. The method of claim 1, further comprising waiting to receive a second acknowledgment response corresponding to the second preamble when the first acknowledgement response is for the first preamble.

4. The method of claim 1, further comprising transmitting the scheduling request based at least in part on uplink timing and/or power information carried in the first acknowledgment response when the first acknowledgement response is for the second preamble.

5. The method of claim 1, further comprising transmitting an uplink dedicated physical channel (UL DPCH) based at least in part on uplink timing and power information carried in the first acknowledgement response regardless of which preamble is acknowledged.

6. The method of claim 1, in which the first acknowledgment response is a fast physical access channel (FPACH).

7. An apparatus for wireless communication, comprising:
means for transmitting a first preamble for a random access procedure and a second preamble for a scheduling request in response to receiving a hard-handover command;
means for receiving a first acknowledgment response to one of the preambles; and
means for determining when to transmit the scheduling request based at least in part on which preamble is acknowledged.

8. The apparatus of claim 7, further comprising means for waiting to receive a second acknowledgment response corresponding to the second preamble when the first acknowledgement response is for the first preamble.

9. The apparatus of claim 7, further comprising means for transmitting the scheduling request based at least in part on uplink timing and/or power information carried in the first acknowledgment response when the first acknowledgement response is for the second preamble.

10. The apparatus of claim 7, further comprising means for transmitting an uplink dedicated physical channel (UL DPCH) based at least in part on uplink timing and power information carried in the first acknowledgement response regardless of which preamble is acknowledged.

11. An apparatus for wireless communication, comprising:
a memory; and
at least one processor coupled to the memory and configured:
to transmit a first preamble for a random access procedure and a second preamble for a scheduling request in response to receiving a hard-handover command;
to receive a first acknowledgment response to one of the preambles; and
to determine when to transmit the scheduling request based at least in part on which preamble is acknowledged.

12. The apparatus of claim 11, in which the at least one processor is further configured to substantially simultaneously transmit the first and second preambles for the random access procedure and the scheduling request in parallel.

13. The apparatus of claim 11, in which the at least one processor is further configured to wait to receive a second acknowledgment response corresponding to the second preamble when the first acknowledgement response is for the first preamble.

14. The apparatus of claim 11, in which the at least one processor is further configured to transmit the scheduling request based at least in part on uplink timing and/or power information carried in the first acknowledgment response when the first acknowledgement response is for the second preamble.

15. The apparatus of claim 11, in which the at least one processor is further configured to transmit an uplink dedicated physical channel (UL DPCH) based at least in part on uplink timing and power information carried in the first acknowledgement response regardless of which preamble is acknowledged.

16. The apparatus of claim 11, in which the first acknowledgment response is a fast physical access channel (FPACH).

17. A computer program product for wireless communication in a wireless network, comprising:
a non-transitory computer-readable medium having program code recorded thereon, the program code comprising:
program code to transmit a first preamble for a random access procedure and a second preamble for a scheduling request in response to receiving a hard-handover command;
program code to receive a first acknowledgment response to one of the preambles; and
program code to determine when to transmit the scheduling request based at least in part on which preamble is acknowledged.

18. The computer program product of claim 17, in which the program code further comprises program code to wait to receive a second acknowledgment response corresponding to the second preamble when the first acknowledgement response is for the first preamble.

19. The computer program product of claim 17, in which the program code further comprises program code to transmit the scheduling request based at least in part on uplink timing and/or power information carried in the first acknowledgment response when the first acknowledgement response is for the second preamble.

20. The computer program product of claim 17, in which the program code further comprises program code to transmit an uplink dedicated physical channel (UL DPCH) based at least in part on uplink timing and power information carried in the first acknowledgement response regardless of which preamble is acknowledged.
